(19) United States
(12) Patent Application Publication
(10) Pub. No.: US 2017/0267068 A1
(43) Pub. Date: Sep. 21, 2017

(54) Car Humidifier

(71) Applicant: Shenzhen Huiqimei Technology Co., Ltd., Shenzhen (CN)

(72) Inventor: Zengtong LIN, Shenzhen (CN)

(73) Assignee: Shenzhen Huiqimei Technology Co., Ltd., Shenzhen (CN)

(21) Appl. No.: 15/320,068

(22) PCT Filed: Jan. 5, 2016
(86) PCT No.: PCT/CN2016/070124

§ 371 Date: Dec. 19, 2016

(30) Foreign Application Priority Data
Sep. 8, 2015 (CN) 201520686209.8

(51) Int. Cl. B60H 3/02; F24F 6/12

(52) U.S. Cl. CPC B60H 3/022; F24F 6/12; B60H 2003/026

(57) ABSTRACT

A car humidifier, which includes a base, a water tank connecting to the base, a waterproof washer for the water tank, an absorbent sponge stick extended between the base and the water tank, an atomization film supported by a bottom support in the base having direct contact between the absorbent sponge stick and the water tank, a waterproof ring for the bottom support, a circuit board electrically connected to the atomization film, an upper case having a spray opening communicate with the atomization film and connected to the base, a positioning seat for rotation mounted to two sides of the base, a cigarette lighter plug connected to the circuit board, a positioning plug coupling to the positioning seat extended on top of the cigarette lighter plug, thereby unnecessary wiring is eliminated. This design is simple, elegant, convenience and easy for use.

### CROSS REFERENCE TO RELATED APPLICATION

This is a national phase national application of an international patent application number PCT/CN2016/070124, filing date Jan. 5, 2016, which claimed priority of Chinese application number 201520686209.8, filing date Sep. 8, 2015. The contents of these specifications, including any intervening amendments thereto, are incorporated herein by reference.

### BACKGROUND OF THE PRESENT INVENTION

### Field of Invention

The present invention relates to a humidifier, and more particular to a car humidifier.

### Description of Related Arts

Humidifier can humidify air inside a space. The humidifiers used inside car vehicles are usually connected to the cigarette lighter receptacle through connecting wires for power supply, thus causing space confusion in the car.

### SUMMARY OF THE PRESENT INVENTION

In order to solve the problems of existing arts, a car humidifier according to the present is provided.

In order to achieve the above object, the following technical solutions are provided:

a car humidifier, which includes an upper casing, an atomization film, a bottom support for atomization film, a circuit board, a waterproof ring, a base, a positioning seat for rotation, a waterproof washer, an absorbent sponge stick, a water tank, a positioning plug for rotation, and a cigarette lighter plug, wherein the water tank has a top water inlet and a screw thread on the top water inlet connecting the base, the absorbent sponge stick has one end securely connected to a center portion of the base and another opposing end extended inside the water tank through the top water inlet, the atomization film is provided in the base and the atomization film is in contact with one end of the absorbent sponge stick, the circuit board is installed in the base and is electrically connected to the atomization film, the base has a top portion connected to the upper case, the upper case has a spray opening communicate with the atomization film, the base has two sides mounting to the positioning seat for rotation, the positioning seat for rotation has an indented groove rotatably mounted to a protruded plug of the positioning plug for rotation, the positioning plug has a bottom portion constructed as the cigarette lighter plug, the cigarette lighter plug is connected to the circuit board.

Preferably, the atomization film is secured into position inside the base through the bottom support for atomization film and the upper casing.

Compared to conventional art, the advantageous effect of the present is that: the present invention does not involve any unnecessary wiring, the design is simple and elegant while convenience and easy for use; the protruded plug and indented groove connecting structure is provided between the positioning plug for rotation and the positioning seat for rotation, therefore a 180 degree of free rotational positioning is achieved. This arrangement can allow the spray opening of the humidifier to adjust to face upward and to allow this car humidifier to fit the cigarette lighter receptacle of cars with different makes and models.

### BRIEF DESCRIPTION OF THE DRAWINGS

FIG. 1 is an exploded view of a car humidifier according to the present invention.

### DETAILED DESCRIPTION OF THE PREFERRED EMBODIMENT

The technical features according to the preferred embodiment of the present invention is further illustrated clearly and completely in details with the accompany drawings in the followings. The embodiment of the present invention as shown and described below is exemplary only and not intended to be limiting. This invention includes all modifications encompassed within the spirit and scope of the present invention and modifications of the present invention which does not involve any inventive steps.

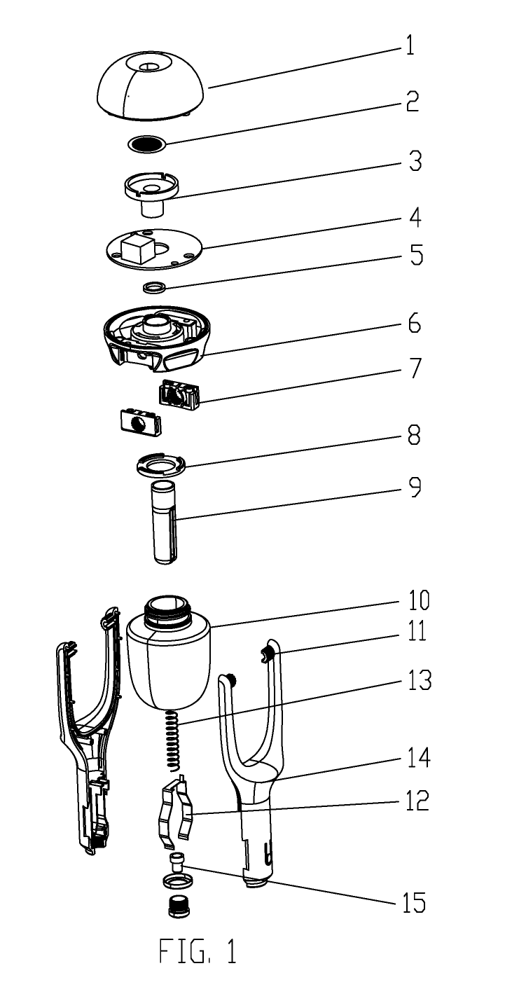

Referring to FIG. 1 of the drawings, the car humidifier according to the present invention comprises: an upper casing 1, atomization film 2, bottom support for atomization film 3, a circuit board 4, a waterproof ring 5, a base 6, a positioning seat for rotation 7, a waterproof washer 8, an absorbent sponge stick 9, a water tank 10, a positioning plug for rotation 11, and a cigarette lighter plug 12, wherein the water tank 10 has a top water inlet and a screw thread on the top water inlet connecting the base 6, the absorbent sponge stick 9 has one end securely connected to a center portion of the base 6 and another opposing end extended inside the water tank through the top water inlet, the absorbent sponge stick 9 utilizes capillary action to aspirate the water from the water, the atomization film 2 is provided in the base 6 and the atomization film 2 is in contact to one end of the absorbent sponge stick 2, through the atomization film 2, the water aspirated from the absorbent sponge stick 9 is atomized, thereby water vapor is produced for humidification of the interior space of a vehicle.

The atomization film 2 is secured into position inside the base 6 through the bottom support for atomization film 3 and the upper casing 1, the circuit board 4 is installed in the base 6 and is electrically connected to the atomization film 2, the atomization film 2 is controlled through the circuit board 4, the base 6 has a top portion connected to the upper case 1, the upper case 1 has a spray opening communicate with the atomization film 2 to facilitate the water vapor to exit through the spray opening of the upper case 1.

The base 6 has two sides mounting to the positioning seat for rotation 7, the positioning seat for rotation 7 has an indented groove structure rotatably mounted to a protruded plug of the positioning plug for rotation 11 such that that the base is capable of positioning in a rotational range of 180 degree, while the positioning plug has a bottom portion connected to the cigarette lighter plug 12, the cigarette lighter plug 12 is connected to the circuit board 4 for supplying power.

The present invention utilizes the cigarette lighter plug to design an integrated humidifier without any unnecessary wiring. The design is simple and elegant while convenience and easy for use.

The rotational position arrangement is provided in the connecting junction of the humidifier arrangement and the cigarette lighter plug, the protruded plug and indented groove connecting structure is provided between the positioning plug for rotation and the positioning seat for rotation, therefore a 180 degree of free rotational positioning is achieved. This arrangement can allow the spray opening of the humidifier to adjust to face upward and to allow this car humidifier to fit the cigarette lighter receptacle of cars with different makes and models.

The rotational position arrangement is formed by the positioning plug for rotation and the positioning seat for rotation such that a rotational connecting relationship between the water tank and the cigarette lighter plug is realized to allow a secure positioning at a particular angle based on the rotational angle of the rotational position arrangement, thereby this car humidifier can universally fit the different cigarette lighter receptacle of cars with different makes and models.

The car humidifiers in the market can utilize the cigarette light receptacle to obtain power supply. However, all of them is connected by electric cables and hence the wiring is extended outside inside the car and. It is very messy when used. The car humidifiers of the present invention is specifically based on the structural design of a cigarette light plug such that no excessive wiring is required. Therefore, the design is simple and elegant, convenience and easy for use, and is a specifically design for humidifying the interior space of a car.

One skilled in the art will understand that the embodiment of the present invention as shown in the drawings and described above is exemplary only and not intended to be limiting. The embodiments have been shown and described for the purposes of illustrating the functional and structural principles of the present invention and is subject to change without departure from such principles. Accordingly, the embodiments are exemplary and non-limiting in any aspects from all points of view.

Therefore, the scope of this invention is defined by the following claims and is not limited by the foregoing description. The present invention includes all changes to the elements of the present invention, and to the equivalent elements of the present invention. The claims are not limited by the numerical reference in the drawings in the claims.

In addition, it is understood that the description of the present invention is based on the preferred embodiment of the present invention, a single embodiment does not necessarily include only one single technical solution. This presentation method of the description is for clear and precisely illustrating the present invention only. The description of the present invention is read as a whole. The technical solutions in different embodiments can be combined if appropriate to form other embodiments which is understood by the skilled person in the art.

While this description is described in terms of embodiments, it does not means that one embodiment includes only a single technical solution. This description of the description is for clarity only and the person skilled in the art should refer to the specification as a whole. The technical solutions of the embodiments may be combined as appropriate to form other embodiments as will be understood by those skilled in the art.

1: A car humidifier, comprising an upper casing, an atomization film, a bottom support for atomization film, a circuit board, a waterproof ring, a base, a positioning seat for rotation, a waterproof washer, an absorbent sponge stick, a water tank, a positioning plug for rotation, and a cigarette lighter plug, characterized in that, said water tank has a top water inlet and a screw thread on said top water inlet connecting said base, said absorbent sponge stick has one end securely connected to a center portion of said base and another opposing end extended inside said water tank through said top water inlet, said atomization film is provided in said base and said atomization film is in contact with one end of said absorbent sponge stick, said circuit board is installed in said base and is electrically connected to said atomization film, said base has a top portion connected to said upper case, said upper case has a spray opening communicate with said atomization film, said base has two sides mounting to said positioning seat for rotation, said positioning seat for rotation has an indented groove rotatably mounted to a protruded plug of said positioning plug for rotation, said positioning plug has a bottom portion constructed as said cigarette lighter plug, said cigarette lighter plug is connected to said circuit board for supplying power.

2: The car humidifier according to claim 1, characterized in that, said atomization film is secured into position inside said base through said bottom support for atomization film and said upper casing.

3: The car humidifier according to claim 1, characterized in that, said absorbent sponge stick is peripherally enclosed by a stick casing and a water passage is provided on said stick casing.

4: The car humidifier according to claim 1, characterized in that, said cigarette lighter plug has a positive terminal, a negative terminal and a spring connected to said positive terminal.

5: The car humidifier according to claim 4, characterized in that, said positive terminal is connected to said circuit board through said spring.

6: The car humidifier according to claim 1, characterized in that, said positioning seat for rotation is formed by two members symmetrically mounted together and said two members are mounted to said two sides of said base respectively.

7: The car humidifier according to claim 1, characterized in that, said positioning plug for rotation is formed by two symmetrical members extended upwardly from the cigarette lighter plug 12.

8: The car humidifier according to claim 1, characterized in that, said positioning seat for rotation has a center connecting hole for coupling with said positioning plug for rotation.
